(19) United States
(12) Patent Application Publication
(10) Pub. No.: US 2013/0253855 A1
(43) Pub. Date: Sep. 26, 2013

(54) Method and Apparatus for Measuring Apparent Viscosity of a Non-Newtonian Fluid

(71) Applicants: Canlong He, St. Peters, MO (US); Paul G. Conley, St. Charles, MO (US); Pieter Martin Lugt, Vianen (NL)

(72) Inventors: Canlong He, St. Peters, MO (US); Paul G. Conley, St. Charles, MO (US); Pieter Martin Lugt, Vianen (NL)

(73) Assignee: LINCOLN INDUSTRIAL CORPORATION, St. Louis, MO (US)

(21) Appl. No.: 13/427,655

(22) Filed: Mar. 22, 2012

(51) Int. Cl. G06F 19/00

(52) U.S. Cl. 702/50

(57) ABSTRACT

Method and apparatus are disclosed for measuring an apparent viscosity of a non-Newtonian fluid. The method and apparatus involves calculating a power-law number n relating a shear stress of the fluid to a shear rate of the fluid, and then calculating an estimated apparent viscosity ηₑₛₜ of the fluid at a selected shear rate based on a yield stress Y of the fluid and on the calculated power-law number n. The estimated apparent viscosity of the fluid at a selected shear rate is calculated based on the experimental observation that reference shear stress is 1.5 times the yield stress for most shear thinning fluids (e.g., grease).

### FIELD OF THE INVENTION

The present invention generally relates to a system, apparatus and a method for measuring the apparent viscosity of a non-Newtonian fluid, such as lubrication greases, inks and adhesives. This information is useful in designing fluid flow systems, such as (but not limited to) fluid dispensing systems and lubrication systems.

### BACKGROUND OF THE INVENTION

Apparent viscosity has been accepted increasingly by design engineers in sizing pumps and other components of fluid flow systems, such as grease lubrication systems. In general, the apparent viscosity of a fluid is defined as shear stress over shear rate. For non-Newtonian fluids, such as grease, the apparent viscosity changes at different shear rates. The standard method for measuring grease apparent viscosity is defined by ASTM D-1092. Using this method, the apparent viscosity of a non-Newtonian fluid can be measured at different shear rates. However, this method has several drawbacks. The test involves expensive equipment and takes time and effort to run. Further, a separate test must be run for each selected shear rate. Also, the test data is not available at shear rates less than 10 sec⁻¹.

U.S. Pat. No. 7,980,118, assigned to Lincoln Industrial Corporation, discloses an improved system, apparatus, and method of estimating the apparent viscosity of a non-Newtonian fluid. While this method is relatively simple and substantially accurate, there is a need for a more precise method of estimating apparent viscosity.

### SUMMARY OF THE INVENTION

This invention is directed to a method and apparatus for more precisely measuring an apparent viscosity of a non-Newtonian fluid by using a novel method, apparatus, and system.

The method comprises the steps of:

a) supplying fluid under pressure to said conduit until the fluid in a pressure zone in the conduit reaches a predetermined pressure;

b) venting the pressure zone of the conduit for a predetermined time interval during which fluid flow in the pressure zone includes a transition between non-Newtonian flow and Newtonian flow;

c) measuring the pressure p in said pressure zone during said time interval before, during, and after said transition to determine a pressure curve during said time interval;

d) measuring and recording an amount of fluid output V vented from the conduit during said time interval;

e) calculating a power-law number n relating a shear stress of the fluid to a shear rate of the fluid based on the conduit length L, the conduit diameter D, the measured pressure p during said time interval, and the amount of fluid output V; and

f) calculating an estimated apparent viscosity ηₑₛₜ of the fluid at a selected shear rate based on a yield stress Y of the fluid after said transition, and on the calculated power-law number n.

The apparatus comprises a conduit for receiving the fluid under pressure. The conduit has an inside diameter D, a length L and a L/D ratio greater than 40. The apparatus also includes a pressure measuring device for measuring the pressure inside the pressure zone of the conduit during a time interval during which fluid flow in the pressure zone includes a transition between non-Newtonian flow and Newtonian flow. The pressure measuring device provides pressure signals indicative of pressure changes inside the conduit during the time interval. The apparatus further comprises a device for measuring an amount of fluid V vented from the conduit during the predetermined time interval, and a controller receiving the pressure signals. The controller provides output information indicative of an estimated apparent viscosity nest of the fluid at a selected shear rate based on a yield stress Y of the fluid after said transition, and on a power-law number “n” relating a shear stress of the fluid to a shear rate of the fluid. The power-law number “n” is calculated based on the conduit length L, the conduit diameter D, and the measured amount of fluid V.

Other objects and features will be in part apparent and in part pointed out hereinafter.

### BRIEF DESCRIPTION OF THE DRAWINGS

FIG. 1 is a schematic view of a fluid dispensing system;

FIG. 2 is a schematic view of a progressive lubrication system;

FIG. 3 is a schematic view of a “Ventmeter” tester used to carry out a prior method of estimating the apparent viscosity of a non-Newtonian fluid;

FIG. 4 is a perspective of an exemplary apparatus incorporating the equipment of FIG. 3;

FIG. 5 is view of a second “Ventmeter” tester used to carry out a prior method of estimating the apparent viscosity of a non-Newtonian fluid;

FIG. 6 is view of a third “Ventmeter” tester used to carry out a prior method of estimating the apparent viscosity of a non-Newtonian fluid;

FIG. 7 is a “Ventmeter” tester used to carry out a method of the present invention for measuring the apparent viscosity of a non-Newtonian fluid; and

FIG. 8 is a graph showing a pressure curve for a non-Newtonian fluid during a test procedure using a method of the present invention.

Corresponding reference characters indicate corresponding parts throughout the drawings.

### DETAILED DESCRIPTION

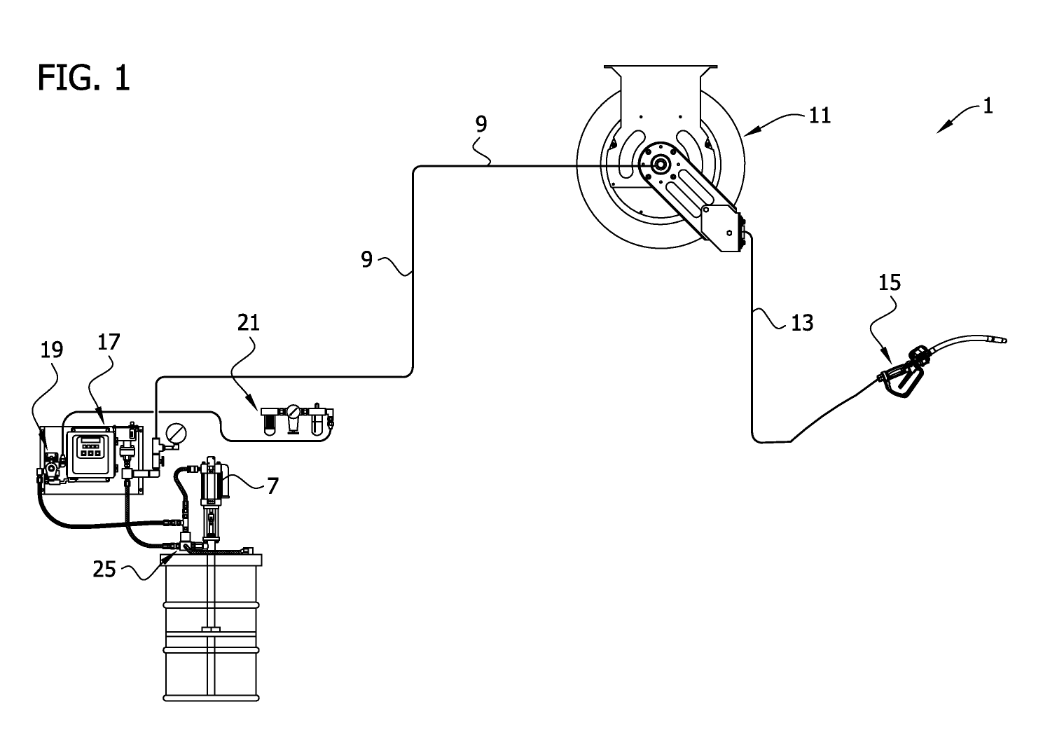

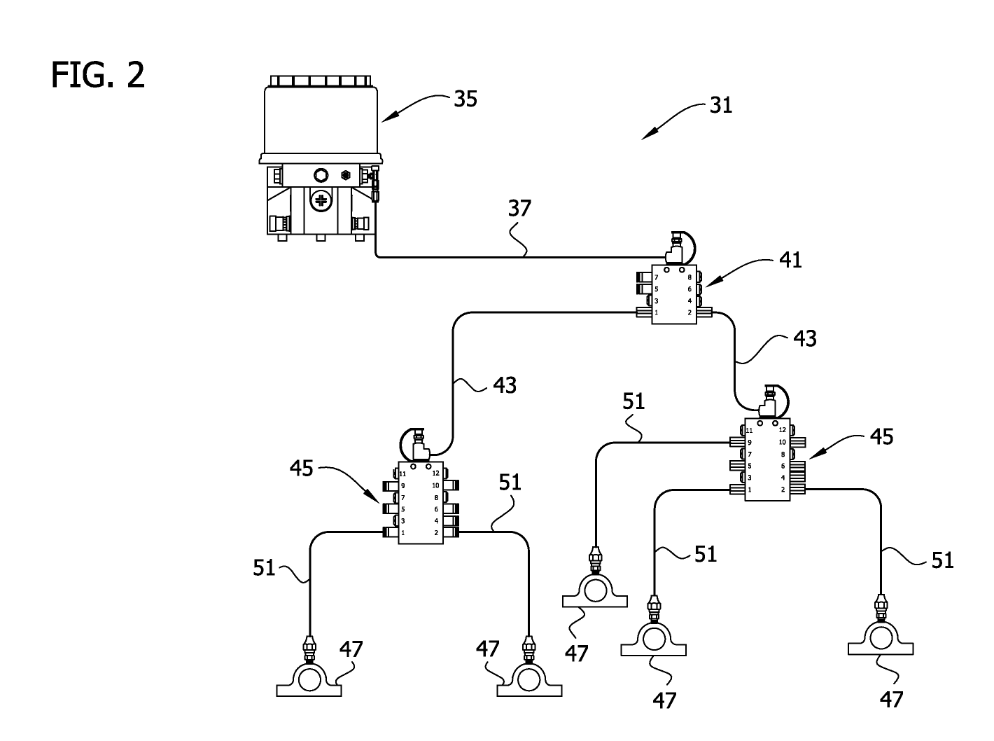

In general, this invention is useful in the design of non-Newtonian fluid flow systems by providing a method of determining apparent viscosity. The design of a fluid flow system involves the determination of pressure drop in the system. To determine pressure drop, it is necessary to know the apparent viscosity of the fluid because the amount of pressure drop will vary depending on the apparent viscosity of the fluid used in the system. As apparent viscosity increases, the pressure drop inside supply and feed lines will also increase, and greater pump power is required for a given flow rate. The converse is also true. As apparent viscosity decreases, the pressure drop will decrease and less pump power will be needed. The method and apparatus of this invention for estimating apparent viscosity of a non-Newtonian fluid can be applied to many fluid flow systems, especially to those with flow generating shear rates in the range of 1-100 sec⁻¹. FIGS. 1 and 2 illustrate two such systems, which are intended to be exemplary only.

FIG. 1 shows a typical fluid dispensing system, generally designated 1. In general, the system comprises a reservoir 5 of lubricating fluid and an air-operated pump 7 for pumping fluid through a supply line 9 attached to a hose reel 11 and from there through a feed line 13 to a dispenser 15. The operation of the system is controlled by controller 17 which operates a solenoid valve 19 to control the supply of pressurized air from a source 21 to the pump and a 3-way vent valve 25 for venting fluid back to the reservoir 5. The fluid power capacity of the pump 7 needs to be properly sized to overcome the pressure drop in both the supply line 9 and the feed line 13. Apparent viscosity is required to calculate the pressure drop over these lines at the required flow rate. Apparent viscosity is also needed to size the tubing or piping when the fluid power capacity of the pump is known.

Similar calculations are necessary to properly size the fluid power capacity of the pump and tubing in a progressive lubrication system, such as the progressive system 31 shown in FIG. 2. In this system a pump 35 pumps fluid through a primary supply line 37 to a primary distributor valve 41 and then through secondary supply lines 43 to secondary distributor valves 45. Fluid is delivered to points of lubrication 47 (e.g., bearings) via feed lines 51 attached to outlets of the secondary distributor valves 45. The flow rate required in such a system can be calculated based on the rate at which fluid is dispensed from the valves 41 and 45. Apparent viscosity is useful information for proper selection of pump capacity, line size, and the limit of the longest fluid path in this system and other systems having various types of fluid dispensers (e.g., injectors, divider valves, fuel meters, etc.).

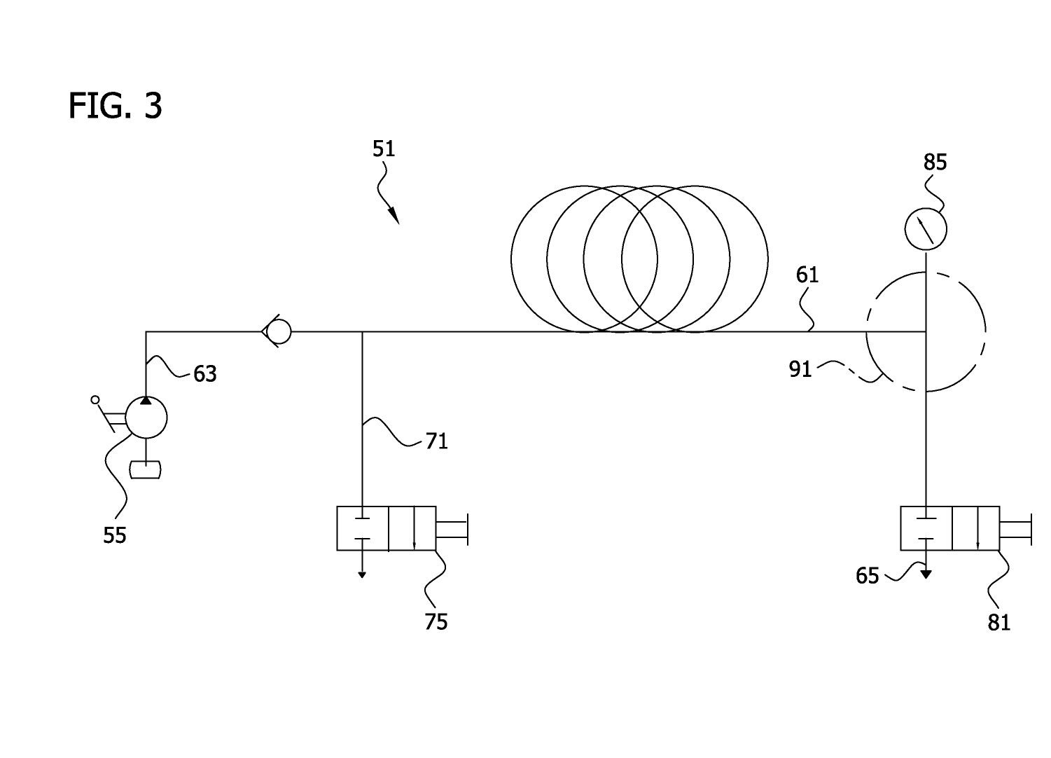

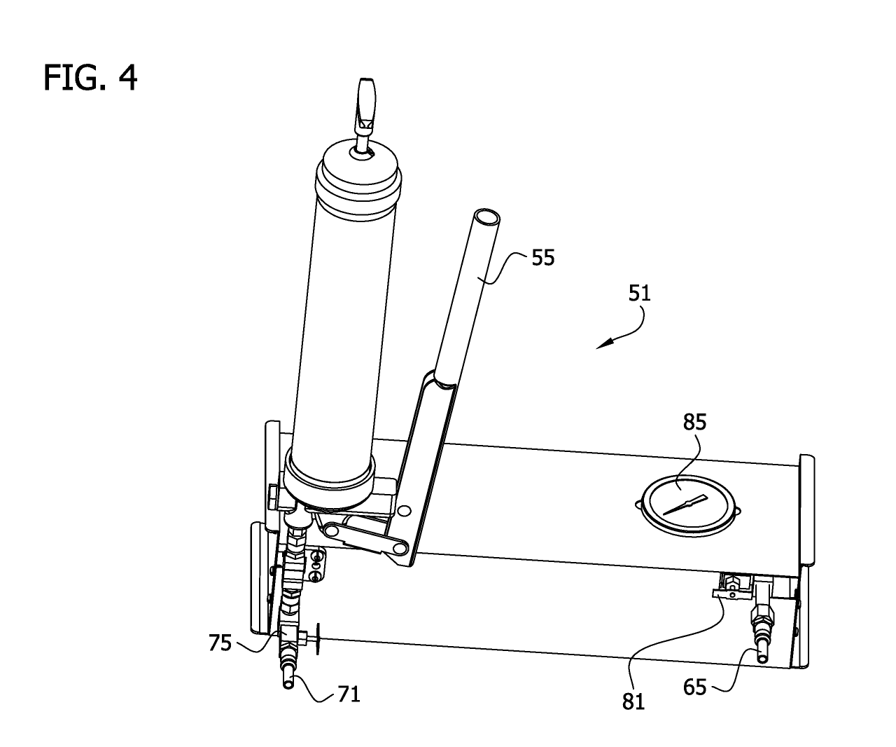

One useful tool that has been used by design engineers is the “Ventmeter” tester, developed years ago by Lincoln Industries of St. Louis, Mo. This tester simulates the conditions and operation of a centralized lubrication system. As shown in FIGS. 3 and 4, the tester 51 is equipped with a pump 55 comprising a manually operated lever-actuated grease gun, a length of conduit comprising a coiled metal tube 61 having an inlet end 63 communicating with the pump and an outlet end 65, a relatively short vent line 71 communicating with the coiled tube 61 downstream from and generally adjacent the pump 55, a valve system comprising a first (venting) valve 75 in the vent line 71, a second valve 81 generally adjacent the outlet end 65 of the coiled tube 61, and a pressure measuring device 85 (e.g., a pressure gauge) upstream from and generally adjacent the second valve 81 for measuring and displaying the pressure in a pressure zone 91 of the coiled tube. This pressure zone 91 is typically the area inside the tube 61 at the location of the pressure measuring device 85.

In one embodiment, the coiled metal tube 61 of the “Ventmeter” has a length of about 25 feet and an inside (flow) diameter of about 0.25 in. The tube may have other lengths and diameters. Desirably, the tube has a length (L) to diameter (D) ratio greater than 40 and even more desirably greater than 500. The vent line 71 has a flow diameter about the same as the flow diameter of the coiled tube 61, and desirably not substantially smaller than that of the coiled tube 61 so that it does not restrict flow from the tube during venting, as will be described.

In one embodiment, the two valves 75, 81 are needle valves movable manually between open and closed positions. In another embodiment, one or both valves are solenoid-operated valves. The first (venting) valve has a flow orifice not substantially smaller in diameter than the flow diameter of the coiled tube, and desirably about the same size or larger than the flow diameter of coiled tube so that the valve does not restrict the venting process, as will be described. Other valve systems are possible, including systems which have only one valve or systems which have more than two valves.

In the embodiment of FIGS. 3 and 4, the pressure measuring device 85 is a pressure gauge. By way of example but not limitation, the pressure gauge may be a mechanical dial gauge with a pressure range of 50-2000 psig.

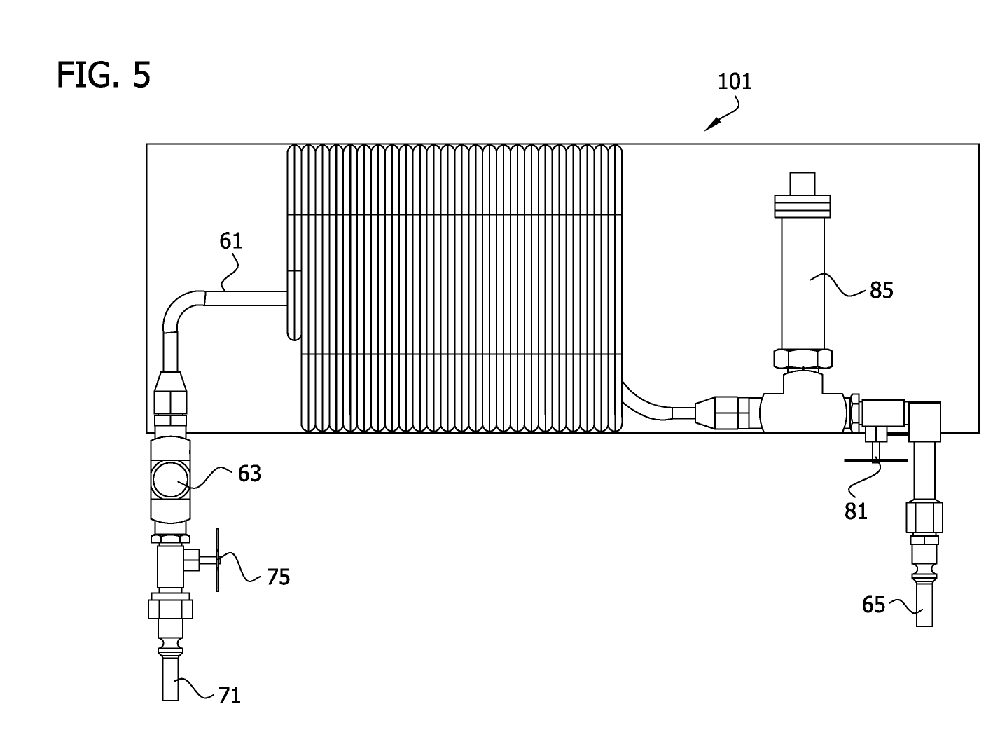

FIG. 5 shows a modified “Ventmeter” apparatus, generally designated 101. The apparatus 101 is similar to the apparatus 51 of the previous embodiment, and corresponding parts are designated by the same reference numbers. In the apparatus 101, the pressure measuring device 85 is a pressure transducer (e.g., a pressure transducer having an analog output), and the valve 75 is a normally-closed solenoid valve. (Other non-solenoid valves may be used.)

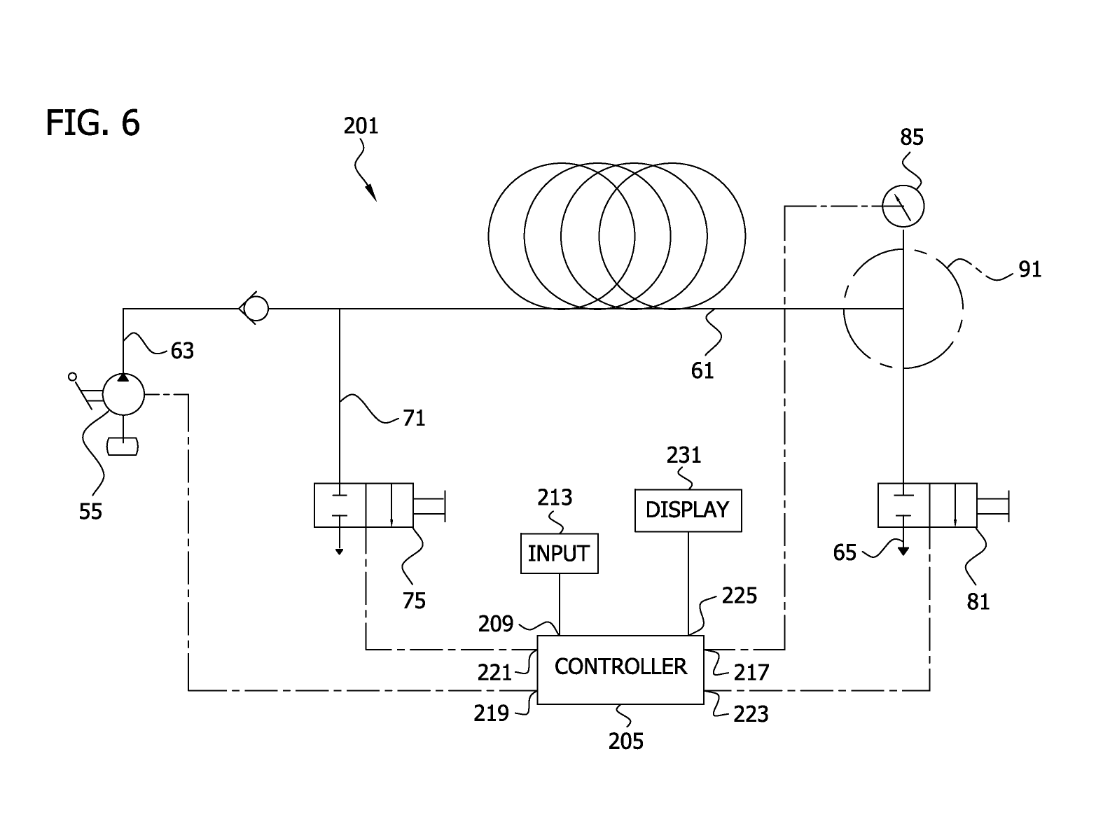

FIG. 6 is a schematic illustration of another embodiment of a Ventmeter apparatus, generally designated 201, as disclosed in U.S. Pat. No. 7,980,118. The apparatus 201 is similar to the embodiments 51 and 101 and corresponding parts are designated by corresponding reference numbers. The apparatus 201 is different in that it further comprises a controller 205 having a first input 209 connected to an input device 213 (e.g., keypad or keyboard) by which a user can input information into the controller, a second input 217 connected to the pressure measuring device 85, a third input 218 from the weighing device 94, a first output 219 for controlling operation of the pump 55, a first output 221 for controlling the operation of the venting valve 75, a second output 223 for controlling the operation of the second valve 81, and a third output 225 connected to a display 231 for displaying information relating to the test procedure. The controller 205 is programmed to run the test procedure described below, to make the various calculations necessary to determine the estimated apparent viscosity and adjusted estimated apparent viscosity, and to record and display the results of the test. The results may be displayed visually in real time as the procedure is in progress or after the procedure is complete. The results are recorded in memory and/or printed out.

Prior to the present invention, the “Ventmeter” tester 51, 101 described above was used to estimate apparent viscosity by using the following test procedure. The pump 55 was operated with the first valve 71 closed and the second valve 81 open to prime the system with the lubricating fluid (e.g., grease) to be tested. After the coiled tube 61 was filled with fluid, the second valve 81 was closed to block further flow through the tube, and the pump 55 was operated to supply fluid under pressure to the coiled tube until the fluid in the conduit (i.e., tube 61) reached a predetermined pressure generally in the range of 1500-2200 psig and desirably about 1800 psig as measured by the pressure measuring device 85. The venting valve 75 was then operated (opened) to vent the coiled tube 61 via the vent line 71. During this venting process, the pressure in the tube 61 decreased, at first rapidly and then more slowly. The venting process was allowed to continue for a “venting” interval of time until the rate of pressure decrease was relatively small (e.g., less than about 5 psi/second over a period of 5 seconds). The pressure in the pressure zone 91 was then measured (using the pressure measuring device 85) and recorded manually. Desirably, the “venting” interval was equal to or greater than 30 seconds for tests conducted at lower temperatures. The weight of fluid vented from the vent line 71 during the “venting” interval was also measured and recorded. This was typically accomplished by collecting and weighing the vented fluid in a suitable manner.

The above information was then used to estimate the apparent viscosity of the lubricating fluid by using a series of calculations, as described below.

First, the wall shear stress of the fluid was calculated using the following formula 1:

τ=PD/4L (formula 1),

where L is the length of the conduit 61, D is the inside diameter (flow area) of the conduit 61, and p is the pressure in the pressure zone 91 as measured by the pressure measuring device 85 at the end of the “venting” interval.

Second, the approximate shear rate of the fluid was calculated using the following formula 2:

Y=(32Q)/(πD³) (formula 2),

where D is the inside diameter (flow area) of the conduit 61, and Q is the flow rate of the fluid vented during the “venting” interval determined by measuring fluid output (weight) over the time of the venting interval.

Third, the apparent viscosity of the fluid was calculated using the following formula 3:

ηₐ=τ/γ (formula 3).

The invention disclosed in U.S. Pat. No. 7,980,118, assigned to Lincoln Industrial Corporation, represented an improvement over the Ventmeter test described above. In the patented test procedure (e.g., see FIG. 6), the estimated apparent viscosity ηₑₛₜ of the fluid at a selected shear rate was determined using a first formula ηₑₛₜ=τ/γₛ, where τ is the calculated wall shear stress and γₛ is the selected shear rate. The determination was based on information including the conduit inside diameter D, conduit length L, and a measurement of the pressure p taken (e.g., in zone 91) during the transition of the fluid from non-Newtonian flow to Newtonian flow. Unlike the previous Ventmeter test, the determination of the estimated apparent viscosity was not based on any measurement of fluid output from the conduit (e.g., conduit 71), thus simplifying the procedure. In addition, the patented method included a step which calculated an “adjusted” estimated apparent viscosity having a value which correlates (compares to) the results of the ASTM D-1092 test method. This step involved the use of a power-law number (sometimes referred to as a power-law index) relating the shear stress of the fluid to the shear rate of the fluid. The power-law number used for the fluid tested was an estimated value and therefore tended to be less than precise.

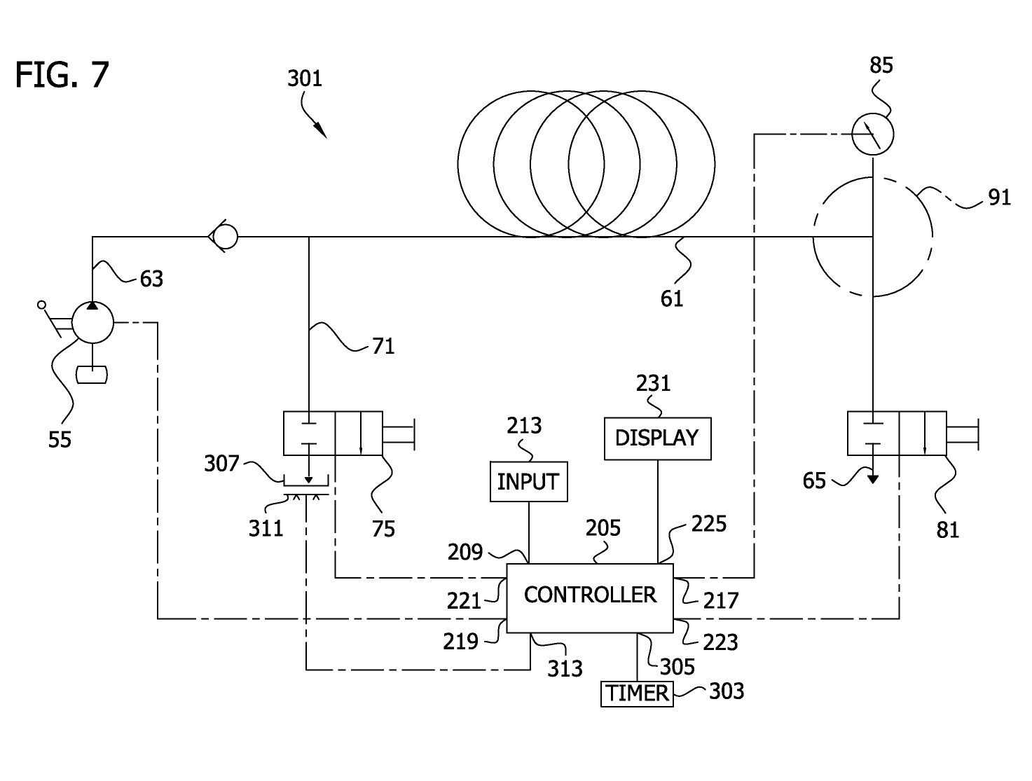

FIG. 7 illustrates an exemplary apparatus, generally designated 301, for carrying out the method of the present invention in which the power-law number is based on a calculation to arrive at a more accurate determination of the estimated apparent viscosity of a non-Newtonian fluid (e.g., grease, ink, mastics, glue). The apparatus 301 is similar in certain respects to the apparatus of FIG. 6 and corresponding parts are designated by corresponding reference numbers. The apparatus 301 includes a timer 303 connected to an input 305 of the controller 205 for controlling a duration of venting time. The timer 301 is set to time out a duration of time (e.g., 40 seconds) for venting of fluid from the vent line 71 after the vent valve 75 (e.g., a solenoid valve) is opened by the controller 205. The apparatus also includes a collector 307 (e.g., a receptacle) for collecting fluid vented out from the vent line 71 during this duration of venting time, and a weighing device 311 for weighing the fluid output so that a vented volume V of fluid can be determined. Desirably, the controller 205 has an input 313 connected to the weighing device. Other devices can be used for determining the vented volume V of fluid.

A method of this invention can be carried out using the apparatus 301, or similar apparatus. The following exemplary steps are taken for a fluid such as grease:

(a) Prime the tube 61 by opening the two valves 65, 75 and operating the pump 55 until fluid flows out from the vent line 71. After fluid flows out from the vent line, close the first valve 75 and operate the pump until lubricant begins to flow out from the second valve 65, indicating that the tube 61 is primed. Then close the second valve 65. The priming process may be carried out manually, or the apparatus may include suitable means (e.g., sensors for sensing flow through the valves 75, 81 and/or lines 65, 71) connected to the controller 205 so that the controller may carry out the priming process automatically.

(b) After the tube 61 is primed, the controller 205 operates the pump 55 to slowly build up pressure to a gauge reading of e.g., 1,800 psig.

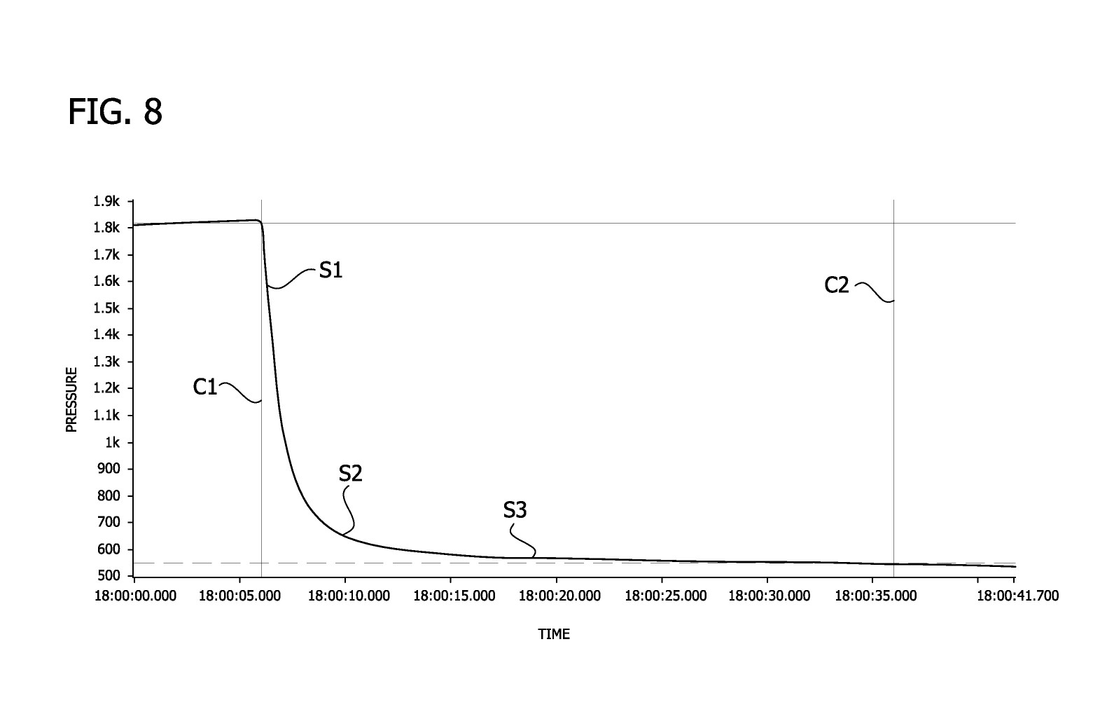

(c) The controller 205 opens the first valve 75 and, simultaneously, starts the timer to time out the preset duration of venting time (e.g., 40 seconds). This duration includes a time interval (e.g., 0-30 seconds) that starts at or near time t=0 (when the pressure first begins to drop), and extends most of the entire duration of venting time, or at least until the rate of pressure drop is minimal (e.g., less than about 5 psi/second over a period of 5 seconds. The controller receives signals from the pressure gauge or transducer 85 during this predetermined interval of venting time and records the pressure at frequent subintervals of time, e.g., every 0.05-0.10 seconds. These pressure readings are used to generate a pressure curve (e.g., see FIG. 8), as will be discussed later. The pressure reading at the end of the predetermined interval of venting time (e.g., at 30 seconds) is recorded as the Ventmeter reading. The data is captured using appropriate data acquisition software, e.g., LabView software.

(d) The fluid vented from the vent line 71 during the predetermined interval of venting time is collected by the collector 307 and weighed by the weighing device 311 which sends this data to the controller 205. The controller uses this data and fluid density to determine the volume of fluid collected during the predetermined interval of venting time. This step of measuring the amount of collected fluid may also be carried out manually.

(e) If desired, steps (c) and (d) above are repeated and the pressure readings are recorded for data post-processing, as described in detail below. This post-processing will provide an average Ventmeter reading, a yield stress for the fluid, and estimated apparent viscosity for the fluid, as described hereinafter.

(f) If desired, steps (a)-(e) can be repeated at warmer and colder temperatures (e.g., 30° F. and 0° F.). Before repeating (a)-(e), the fluid sample and apparatus should be allowed to acclimate to a test temperature lower than ambient temperature for at least four hours.

The Ventmeter reading obtained by the method described in the preceding paragraph is used to calculate yield stress Y, reference shear stress τ₁, and estimated apparent viscosity η, using the calculations set forth below.

### Calculations

Calculate the yield stress Y of the sample of fluid (in this case grease), as follows:

Y=[Pπr²/2πrL]=Pr/2L=(6894757)(PD/4L) (formula 4)

where Y is the yield stress in millipascals (mPa) P is the recorded Ventmeter reading (psi) at the end of the interval of venting time (e.g., at 30 seconds) r is the internal radius of the coiled tubing (in.) D is the internal diameter of the coiled tubing L is the length of the coiled tubing (in.)

Calculate a reference shear stress τ₁ at unit shear rate, as follows:

τ₁=(k)(Y) (formula 5)

where τ₁ is the shear stress at shear rate=1 (S⁻¹), and k is a ratio reflecting the relationship between the shear stress at unit shear rate and yield stress

For most greases, k is about 1.5. This value is obtained from experimental data using a standard AR 1000 rheometer, as further described in Appendix 1 attached to this specification and made a part hereof.

The apparent viscosity of grease delivery systems operating in the shear rate range of 1 to 100 S⁻¹ can be estimated using the following formula η=(k) (Y) (γⁿ⁻¹), where γ is the shear rate in Table 1 below from 1 to 100 S⁻¹. In general, lubrication grease is a shear thinning fluid that observes the power-law relation in a shear rate range of 1˜100 S⁻¹.

TABLE 1

| Shear Rate (S⁻¹) | η (cP) |
|---|---|
| 1 | 893,914 |
| 2 | 550,269 |
| 3 | 414,296 |
| 5 | 289,746 |
| 10 | 178,358 |
| 15 | 134,286 |
| 17 | 123,021 |
| 20 | 109,794 |
| 23 | 99,561 |
| 30 | 82,663 |
| 40 | 67,586 |
| 50 | 57,811 |
| 67 | 47,102 |
| 80 | 41,604 |
| 100 | 35,587 |

Applying a proper power-law number (or index) to the shear rate of interest according to the following formula would estimate apparent viscosity to the shear rate of interest:

η=(1.5)(Y)(γ)ⁿ⁻¹ (formula 6)

The power-law number n is determined with information based on pressure changes during an interval of venting time and the volume of grease output during this interval of venting time. The actual value of n is numerically integrated and iteratively solved based on the following equation:

$$\frac{1}{{V}_{1}} {\int }_{{t}_{0}}^{{t}_{1}} {p}^{\frac{1}{n}} d t - {( \frac{128 KL}{π {D}^{4}} )}^{\frac{1}{n}} {( \frac{( 3 n + 1 )}{4 n} )}^{\frac{n - 1}{n}} {( \frac{32}{π {D}^{3}} )}^{\frac{n - 1}{n}} = 0 \qquad ( formula 7 )$$

where V₁ is the volume of grease output during the interval of venting time,
p is instantaneous pressure measured at subintervals during the interval of venting time,
D is the internal diameter of coil tubing, and
K is the consistency of the fluid (K=(k) (Y)).

The equation of formula (7) can be iteratively solved with pressure data, grease output, and an estimated trial-and-error power-law number during the time interval beginning at t₀=0 and ending at t₁ (e.g., t₁=30 seconds). The first term in the equation of formula (7)

$$( i . e . , \frac{1}{{V}_{1}} {\int }_{{t}_{0}}^{{t}_{1}} {p}^{\frac{1}{n}} d t ) ,$$

is referred to herein as term A. The second term in the equation of formula (7)

$$( i . e . , {( \frac{128 KL}{π {D}^{4}} )}^{\frac{1}{n}} {( \frac{( 3 n + 1 )}{4 n} )}^{\frac{n - 1}{n}} {( \frac{32}{π {D}^{3}} )}^{\frac{n - 1}{n}} ) ,$$

is referred to herein as term B. The pressure p is an instantaneous pressure corresponding to a discrete number of pressure readings taken during subintervals over the period beginning at t₀ and ending at t₁. The integral of the first term A of the pressure p over the period beginning at t₀ and ending at t₁ is a summation of the integral of the pressure p during each subinterval which begins and ends with a pressure reading. In other words, the integral of the changing pressure p over the period beginning at t₀ and ending at t₁ is a summation of the area under the pressure curve (e.g., see FIG. 8) for the subintervals between t₀ and t₁. For example, for t₁=30 seconds and for thirty one-second subintervals between t₀ and t₁=30 seconds, the integral of term A is the summation of the integral of the pressure p during the subinterval beginning at t=0 and ending at t=1 second plus the integral of the pressure p during the subinterval beginning at t=1 second and ending at t=2 seconds and so on to and including the integral of the pressure p during the subinterval beginning at t=29 seconds and ending at t₁=30 seconds.

The first term A in the equation of formula (7)

$$( i . e . , \frac{1}{{V}_{1}} {\int }_{{t}_{0}}^{{t}_{1}} {p}^{\frac{1}{n}} d t ) ,$$

will be numerically integrated with an initial estimated power-law number. The second term B in the equation of formula (7)

$$( i . e . , {( \frac{128 KL}{π {D}^{4}} )}^{\frac{1}{n}} {( \frac{( 3 n + 1 )}{4 n} )}^{\frac{n - 1}{n}} {( \frac{32}{π {D}^{3}} )}^{\frac{n - 1}{n}} ) ,$$

will be calculated with known K, L, D and the initial estimated power-law number n. Both the first term A and the second term B are iteratively calculated based on an estimated trial-and-error power-law number. After obtaining terms A and B by using the initial estimated power-law number, a difference A-B of the two terms is then compared against a sum A+B of the two terms. This comparison can be expressed as the following mathematical expression: (A−B)/(A+B). Additional estimated power-law numbers are used to calculate terms A and B in order to reduce the value of the mathematical expression (A−B)/(A+B). The actual power-law number n is selected as the estimated power-law number when the solution of the mathematical expression (A−B)/(A+B) approaches zero, e.g., the expression is in a range of ±0.05%. The power-law number n derived by this iterative process of solving formula (7) is relatively precise for non-Newtonian fluids (e.g., grease, ink, mastic, glue).

Formula (7) is derived as follows:

The Hagen-Poisseuille law for pipe is:

$$p = \frac{128 η LQ}{π {D}^{4}}$$

In the shear rate range of venting, the apparent viscosity of grease can be approximated with the following power-law equation:

η=Kγ_{\dot{γ}}ⁿ⁻¹

where n is a power-law number,
K is the consistency, and
\dot{γ} is the corrected shear rate in a circular pipe.

$$\dot{γ} = \frac{( 3 n + 1 )}{4 n} \frac{32 Q}{π {D}^{3}}$$

where Q is the flow rate (m³/s).

### Therefore,

$$η = {K ( \frac{( 3 n + 1 )}{4 n} \frac{32 Q}{π {D}^{3}} )}^{n - 1} = {K ( \frac{( 3 n + 1 )}{4 n} )}^{n - 1} {( \frac{32}{π {D}^{3}} )}^{n - 1} {( \frac{d V}{d t} )}^{n - 1}$$

### Therefore,

$$p = \frac{128 η LQ}{π {D}^{4}} = \frac{128 L}{π {D}^{4}} {K ( \frac{( 3 n + 1 )}{4 n} )}^{n - 1} {( \frac{32}{π {D}^{3}} )}^{n - 1} {( \frac{d V}{d t} )}^{n}$$

### Therefore,

$${p}^{\frac{1}{n}} = {( \frac{128 KL}{π {D}^{4}} )}^{\frac{1}{n}} {( \frac{( 3 n + 1 )}{4 n} )}^{\frac{n - 1}{n}} {( \frac{32}{π {D}^{3}} )}^{\frac{n - 1}{n}} ( \frac{d V}{d t} )$$

### Or

$$\frac{1}{{V}_{1}} {\int }_{0}^{{t}_{1}} {p}^{\frac{1}{n}} d t - {( \frac{128 KL}{π {D}^{4}} )}^{\frac{1}{n}} {( \frac{( 3 n + 1 )}{4 n} )}^{\frac{n - 1}{n}} {( \frac{32}{π {D}^{3}} )}^{\frac{n - 1}{n}} = 0$$

### Example

The following example is illustrative of the method described above.

### Data Recording

The data recording step (c) of the method described above may be accomplished using a LabVIEW data acquisition module to create a pressure drop graph or curve, such as the pressure curve exemplified in FIG. 8. The pressure data logging starts as soon as the valve 75 is powered on, and readings are taken at frequent subintervals. After 35-40 seconds (a preset duration of venting time during which the valve 75 remains open, as determined by the timer 303), the data recording is stopped. The pressure curve is analyzed over a selected interval of venting time, e.g., between time t=0 when the pressure first begins to drop, and time t=30 seconds. (Typically, the rate of pressure drop after 30 seconds is minimal and can be ignored.) The pressure after venting for 30 seconds is logged as the Ventmeter reading. If desired, the process is repeated a number of times (e.g., three times) with a corresponding number of readings recorded, as described in step (c) in the preceding paragraph. These Ventmeter readings can be averaged to determine an average Ventmeter reading.

In cold temperature testing, the Ventmeter reading is desirably taken after the unit has soaked in the low temperature environment overnight. The test procedure is otherwise identical to ambient temperature testing. Cold temperature testing using the Ventmeter apparatus of FIG. 3 (with exposed coils) allows the grease temperature inside the conduit 61 to rapidly change with the environment.

As noted above, FIG. 8 illustrates an exemplary pressure curve generated using the pressure readings taken during the Ventmeter test. It will be observed from this graph that the pressure curve has three distinct segments. The first segment S1 has a steep relatively constant downward slope indicating a sharp rate of pressure drop (characteristic of non-Newtonian fluid flow). The third segment S3 has a shallow relatively constant downward slope indicating a small rate of pressure drop (characteristic of Newtonian fluid flow). The second segment S2 has a changing (curvilinear) slope indicating a transition from non-Newtonian fluid flow to Newtonian fluid flow. The specific shape of the curve varies according to such factors as the type of non-Newtonian fluid being tested and the temperature conditions. In general, however, all Non-Newtonian fluids (e.g., greases, ink and adhesives) will exhibit the same type of three-segment curve. Further, for such fluids at room temperature, the transition from non-Newtonian fluid flow to Newtonian fluid flow generally starts reasonably quickly (e.g., at about time t=1 second) and ends reasonably quickly (e.g., before time t=10 seconds, and typically before time t=5 seconds).

The pressure measurements taken during the interval of venting time (e.g., thirty seconds) should be taken at suitable subintervals before, during, and after the period of time during which the fluid transitions from non-Newtonian fluid flow to Newtonian fluid flow. That is, the pressure readings should be taken during segments S1, S2, and S3 of the pressure curve (see FIG. 8). Desirably, the pressure readings start as soon as the pressure begins to drop at time t=0 seconds (at or shortly after the valve 75 opens) and continue until the rate of pressure drop is minimal (e.g., less than about 5 psi/second over a period of 5 seconds), which typically occurs after about 30 seconds in the case of grease. (This 30-second time interval may vary, so long as it extends past the transition of the fluid from non-Newtonian to Newtonian flow.) The pressure measurements should be sufficiently frequent to generate a reasonably accurate pressure curve. By way of example but not limitation, the measurements can be taken at subintervals every 0.05-0.1 seconds.

The power-law number n for a non-Newtonian fluid (e.g., grease, ink, mastic, glue) is derived using the calculation described above and in Appendix 1.

### Data Processing and Calculation

In the data recording step described above, three Ventmeter readings were obtained. In FIG. 8, the Ventmeter pressure recording was marked with two cursors C1, C2. The first cursor C1 marks the start of the duration of venting time, i.e., at time t=0 when the pressure first begins to drop, after valve 75 opens. The second cursor C2 marks the residual pressure after venting for a typical interval of venting time, e.g., 30 seconds. The pressure reading at time t=30 seconds is recorded as the Ventmeter reading. In this example, three recordings were processed to obtain an average Ventmeter pressure reading of 545.9 psi. This Ventmeter result is used to calculate yield stress Y, reference shear stress τ₁ and estimated apparent viscosity η. The calculation steps of this example are described below.

Using formula (4) above,

Y=(6894757)(545.9)(19/4)(300)=595,943 (mPa)

where the average Ventmeter reading is 545.9 psi,
the coiled tubing ID is 0.19 in, and
the coiled conduit length is 300 in.

Using formula (5) above,

$$\begin{matrix}{τ}_{1} = ( 1.5 ) ( 595 , 943 ) \\ = 893 , 914 ( m Pa )\end{matrix}$$

Consistency K=(k) (Y) has the same value of τ₁ but a different unit. That is to say, K=τ₁=893,914 (mPa·sⁿ). Using formula (6) above,

η=K(γⁿ⁻¹)=(1.5)(Y)(γⁿ⁻¹)=(893,914)×(γⁿ⁻¹)

where γ is the shear rate of interest in column 1 of Table 1.

The power-law number n is iteratively determined based on formula (7) above using the pressure data acquired by taking readings from the pressure transducer of the Ventmeter apparatus in FIG. 7 at subintervals of Δt=0.1 second. The value of the power-law index or number n is selected as the solution when the term (A−B)/(A+B) approaches zero, e.g., is in a range of ±0.05%. It will be observed that the term (A−B)/(A+B) is very sensitive to the change of the power-law number or index.

After the power-law number n has been determined, the apparent viscosity at each shear rate of interest can be estimated based on power-law in the applicable shear rate of range 1-100 S⁻¹, using formula (6) above. For example, if the power-law number is 0.30, the estimated apparent viscosity at shear rate=20 S⁻¹ is (893, 914) (20)^{(0.3-1)}=109, 794. Similarly the estimated apparent viscosity at γ=10 S⁻¹ is η₁₀=(893,914) (10)^{(0.3-1)}=(89,391) (10)^{-0.70}=178,358. Column 1 of Table 1 lists the shear rate of interest, and column 2 lists the estimated apparent viscosity values using the method described above.

Thus, based on the foregoing, it will be apparent to the skilled person that an improved method of the present invention comprises, in generally, the steps of:

a) supplying fluid under pressure to the conduit (e.g., 61 in FIG. 7) until the fluid in the conduit reaches a predetermined pressure;

b) venting the conduit for a time interval (e.g., a 30-40 second interval) during which fluid flow in the pressure zone includes a transition between non-Newtonian flow and Newtonian flow;

c) measuring and recording changes in pressure p in the conduit during said time interval before, during, and after said transition to determine a pressure curve; and

d) measuring (e.g., weighing) and recording an amount of fluid output V vented from the conduit (e.g., from vent line 71) during the time interval using an appropriate measuring device (e.g., weighing device 311 in FIG. 7);

e) calculating a power-law number n relating a shear stress of the fluid to a shear rate of the fluid based on the conduit length L, the conduit diameter D, the measured pressure p, and the amount of fluid output V (see formula (7)); and

f) calculating an estimated apparent viscosity ηₑₛₜ of the fluid at a selected shear rate based on a yield stress Y of the fluid after said transition, and on the calculated power-law number n (see formula (6)).

The apparatus and method of this invention can be used to estimate apparent viscosity in the range of 1-150 sec⁻¹ and even more desirably in the range of 1-100 sec⁻¹. The method is practical and efficient, and the method can be carried out using the apparatus 301 described above or similar apparatus, which is relatively inexpensive. Unlike the prior Ventmeter procedures, the power-law number n is based on a calculation, not an estimation, from which more accurate estimated apparent viscosities can be derived. Another advantage of this method is that it allows the estimation of apparent viscosity at any shear rate value within a range of at least 1-100 sec⁻¹.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules on a tangible computer readable storage medium. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Having described aspects of the invention in detail, it will be apparent that modifications and variations are possible without departing from the scope of aspects of the invention as defined in the appended claims.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A method of measuring an apparent viscosity of a non-Newtonian fluid by using apparatus comprising a conduit for receiving said fluid under pressure, said conduit having an inside diameter D, a length L and a L/D ratio of at least about 40, said method comprising the steps of:
a) supplying fluid under pressure to said conduit until the fluid in the conduit reaches a predetermined pressure;
b) venting the conduit for a time interval during which fluid flow in the conduit includes a transition between non-Newtonian flow and Newtonian flow;
c) measuring and recording changes in pressure p in the conduit during said time interval before, during, and after said transition to determine a pressure curve;
d) measuring an amount of fluid output V vented from the conduit during said time interval;
e) calculating a power-law number n relating a shear stress of the fluid to a shear rate of the fluid based on the conduit length L, the conduit diameter D, the measured pressure p, and the amount of fluid output V; and
f) calculating an estimated apparent viscosity ηₑₛₜ of the fluid at a selected shear rate based on a yield stress Y of the fluid after said transition, and on the calculated power-law number n.

2. The method set forth in claim 1, further comprising the steps of:
g) calculating the yield stress Y of the fluid based on conduit length L, conduit diameter D, and a measured pressure p after said transition; and
h) determining the estimated apparent viscosity ηₑₛₜ of the fluid at a selected shear rate using a first formula ηₑₛₜ=(1.5) (γₛ)ⁿ⁻¹, where Y is said calculated yield stress, γₛ is the selected shear rate, and n is the power-law number.

3. The method set forth in claim 1, wherein step (e) comprises performing an integration step to determine an area under the pressure curve, and wherein said calculating step comprises calculating the power-law number n based on the conduit length L, the conduit diameter D, the determined area under the pressure curve during said time interval, and the amount of fluid output V.

4. The method set forth in claim 1 wherein the selected shear rate is in the range of 1-100 sec⁻¹.

5. The method set forth in claim 1, further comprising determining a range of estimated apparent viscosities ηₑₛₜ using different selected shear rates in the range of 1-100 sec-1.

6. The method set forth in claim 1, wherein said pressure p is measured at subintervals during said time interval, and wherein said calculating step comprises calculating the power-law number n based on the conduit length L, the conduit diameter D, the determined area under the pressure curve during said time interval, and the amount of fluid output V.

7. The method set forth in claim 6, wherein said measuring the pressure p comprises measuring the pressure at subintervals of at least every 0.1 seconds.

8. The method set forth in claim 6, wherein the power-law number n is calculated using the following equations:
$$A = \frac{1}{{V}_{1}} {\int }_{0}^{{t}_{1}} {p}^{\frac{1}{n}} d t , \\ B = {( \frac{128 KL}{π {D}^{4}} )}^{\frac{1}{n}} {( \frac{( 3 n + 1 )}{4 n} )}^{\frac{n - 1}{n}} {( \frac{32}{π {D}^{3}} )}^{\frac{n - 1}{n}} , and \\ A - B = 0$$
wherein
V₁ is the volume of fluid output during said time interval;
p is instantaneous pressure measured at said subintervals during said time interval;
D is the conduit diameter;
0-t₁ is said time interval;
K is consistency, and
wherein the power-law number is determined by iteratively solving said equations until (A−B)/(A+B) approaches zero.

9. The method set forth in claim 1 wherein said measuring an amount of fluid comprises collecting and weighing said fluid output.

10. Apparatus for measuring an apparent viscosity of a non-Newtonian fluid comprising:
a conduit for receiving said fluid under pressure, said conduit having an inside diameter D, a length L and a L/D ratio greater than 40;
a pressure measuring device for measuring the pressure inside the conduit during a time interval during which fluid flow in the pressure zone includes a transition between non-Newtonian flow and Newtonian flow, said pressure measuring device providing pressure signals indicative of pressure changes inside the conduit during the time interval;
a device for measuring an amount of fluid V vented from the conduit during said time interval; and
a controller receiving the pressure signals,
the controller providing output information indicative of an estimated apparent viscosity ηₑₛₜ of the fluid at a selected shear rate based on a yield stress Y of the fluid after said transition, and on a power-law number n relating a shear stress of the fluid to a shear rate of the fluid, the power-law number n being calculated based on the conduit length L, the conduit diameter D, and the measured amount of fluid V.

11. The apparatus of claim 10 wherein said measuring device comprises a weighing device for weighing said amount of fluid V, said controller being configured to receive signals from the weighing device.
